(19) United States
(12) Patent Application Publication
(10) Pub. No.: US 2006/0078661 A1
(43) Pub. Date: Apr. 13, 2006

(54) Sterilization machine on vegetable and fruit

(76) Inventor: Ching-Hua Wang, Hsin Chuang City (TW)

Correspondence Address: RABIN & BERDO, P.C., Suite 500, 1101 14th Street, N.W., Washington, DC, 20005, US

(21) Appl. No.: 10/960,963

(22) Filed: Oct. 12, 2004

(51) Int. Cl. A23L 3/16

(52) U.S. Cl. 426/521

(57) ABSTRACT

This is a new kind of practical sterilization machine on vegetable and fruit. Its characteristic is the specially designed container for laying vegetable and fruit and the cone in the center for washing. Its bottom design contains balance circle, reflux blades and revolving axis. Starting the reflux equipment, the basket will revolve along with the current direction. The ultrasonic implement, producing vibration frequency, can shake the dirty and poison away. Starting the reflux equipment, ozone, produced by the generator, will dissolve with water and get lots of bubbles as a result of sterilizing, resolving the poison, cleaning, and keeping fresh. At the bottom is the automatic equipment for draining. In a word, it can overcome the defect of hands-washing. It certainly is a kind of practical and economic product.

### FIELD OF THE INVENTION

This practical new machine refers to sterilization and cleaning, especially for vegetable and fruit.

### BACKGROUND OF THE INVENTION

People always wash vegetable and fruit by hands. However, firstly, it is difficult to wash away the dirty, impurity on the leaves of vegetable. Secondly, the poison adhered to the surface of vegetable and fruit is impossible to resolve. As a result, people suffer the acute and chronic intoxication by long-term eating the poisonous vegetable and fruit. So their health is seriously destroyed. Thirdly, it is inconvenient to wash in cold winter or in some cold area. Therefore, it is beneficial to research a scientific cleaning machine to wash away the dirty, resolve the poison and sterilize for keeping the vegetable and fruit fresh. Certainly it will not injure human body.

### SUMMARY OF THE INVENTION

The purpose is to offer the sterilization and cleaning machine. And its designs include: ultrasonic equipment for discharging dirty, ozone generator for sterilization, bubbles to enrich oxygen for keeping fresh, and the desiccation technology by the power of revolving current. It will resolve the problem of inefficient technology and inconvenience of using washing machine.

In order to achieve the above purpose, this practical new machine's structural concept is the vegetable and fruit's sterilization and cleaning, including the two outer shells top and below. Inside the shells, there is a stainless steel slot. The basket with the reflux blades on the edge is designed in the slot. On the top of the basket, there is a concave parenthetical cover and in the middle there is a cone. The balance localization axis is on the top of the cone, connecting with the top shell, also having a slot, to achieve the top balance localization and reduce the fricative traction. At the bottom of the basket there is another slot to achieve the below balance localization. And under it there is a filtering web laying on the bottom of the stainless steel. Around the web there is a balance localization circle. On the edge of the top shell there is a draining aperture to control the water level. Under the shell there is an aperture and a draining exit. In the slot of the stainless steel there is an aperture for discharging dirty and at the flat bottom there is an ultrasonic implement. The below shell is isolated completely with the washing slot, where is put the related accessories. Such as, ozone generator, reflux motor equipment, draining controller and draining duct, which are convenient for producing, fitting and maintenance.

The Beneficial Results of This Machine as Follows:

\textcircled{1} There is a cone in the middle of the specially designed basket for laying vegetable and fruit, being helpful for ultrasonic conduction and improving the soakage effect. It will make full use of the physical theory and lots of reflux blades outside the basket. When the water strikes the blades, the basket will revolve along with the water so that it can easily wash away the dirty and impurity.
\textcircled{2} Starting the reflux equipment, ozone, dissolved with the water, can sterilize and clear away the poison on the surface of the vegetable and fruit.
\textcircled{3} Starting the ozone generator, ozone will produce bubbles, which are good for washing, sterilization and keeping fresh.
\textcircled{4} The ultrasonic implement is designed at the bottom of slot. It can produce high frequency vibration to wash quickly and cleanly. Dirty and poison are vibrated in the slot.
\textcircled{5} Water lever controllers and controllers for draining clean and wasted water are automatically operated.
\textcircled{6} The accessories of this kind of machine are smart, serviceable, convenient fitting and maintenance.
\textcircled{7} Apply to the low fraction theory to improve the revolving power. Therefore, the basket will produce centrifugal power to desiccate the vegetable and fruit.
\textcircled{8} It is inconvenient to wash the vegetable and fruit due to the cold water in some cold area or in cold winter. But, the new machine can overcome that.
\textcircled{9} The concave parenthetical design of the basket cover can keep the vegetable and fruit in water, without flowing out.
\textcircled{10} This machine is the product of fully using physical science and technology. It is smart, practical, and can save electricity while have low noise.

Above all, this product is highly practical and economic. It completely overcomes the inconvenience of hands-washing and the disadvantage of inefficient technology.

### BRIEF DESCRIPTION OF THE DRAWINGS

FIG. 1 is a separate and composing figure of the invention; and

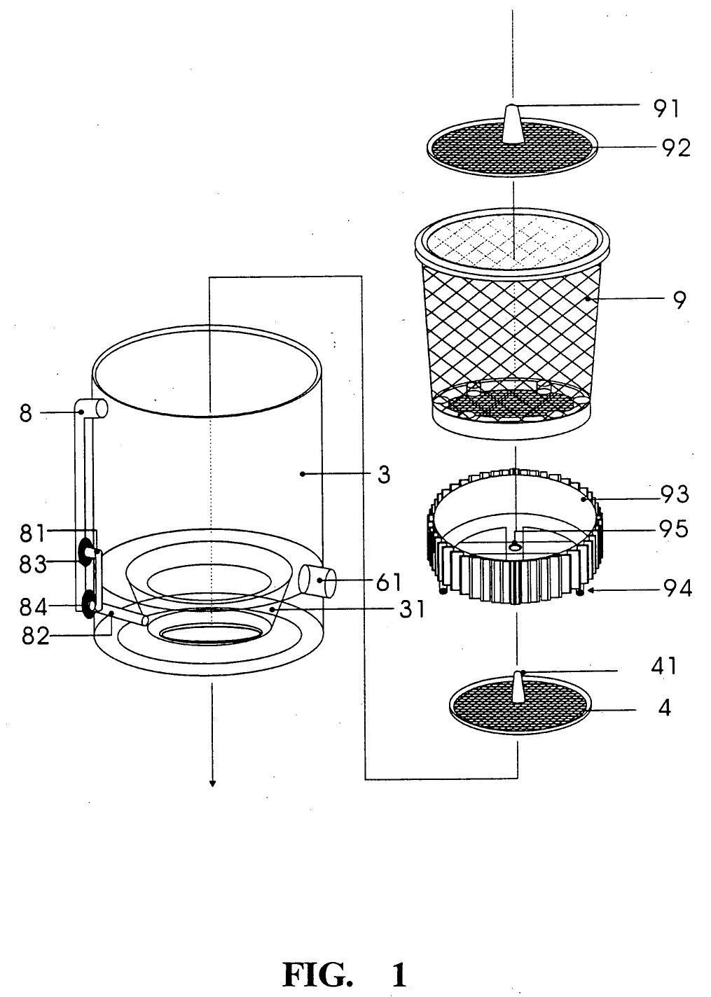

FIG. 2 is a sectional figure of the invention

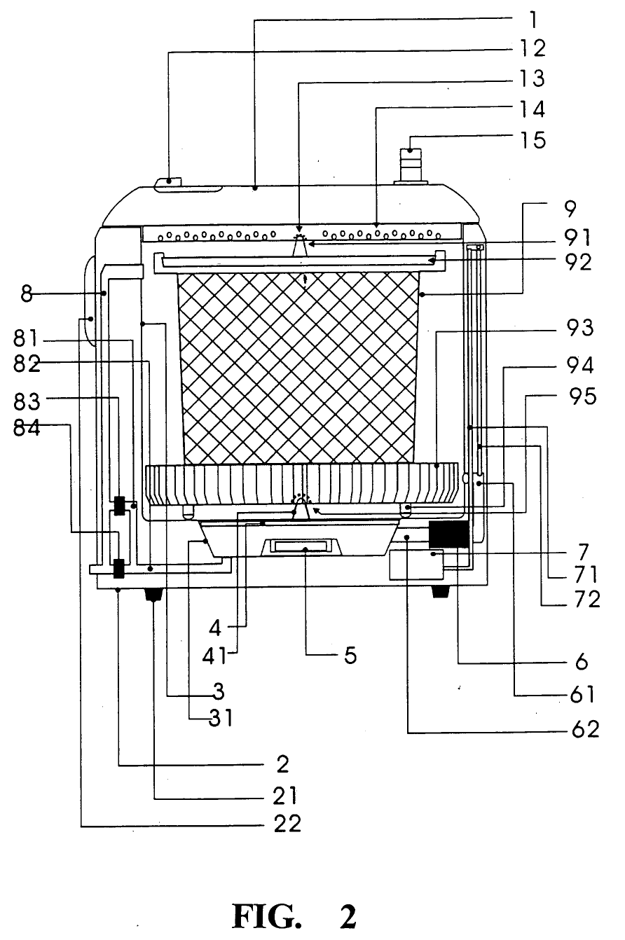

### RELATED ACCESSORIES

1. Top Cover of the Outer Shell
2. The Bottom of the Outer Shell
3. Overflowing Aperture
4. Water Entrance
4. Stainless Steel Slot
6. Reflux Entrance
7. Reflux Exit
8. Reflux Controller
9. Ozone Generator
10. Top Cover
11. Switch Handle Axis
12. Balance Localization Revolving
13. Computer Control Board
14. Basket for Laying Vegetable and Fruit
15. Balance Localization Axis
16. Machine Producing Bubbles
17. Current Revolving Blades
18. Revolving Blades
19. Balance Circle
20. Filtering Web
21. Ultrasonic Implement
22. High-low Water Level Controllers
23. Draining Wasted Water Aperture
24. Draining Controller
25. High Water Level Sensor
26. Low Water Lever Sensor
27. Below Balance Localization Slot
28. Top Balance Localization Slot
29. Basket Cover

### DETAILED DESCRIPTION OF THE PREFERRED EMBODIMENTS

Refer to the drawings and related accessories. This new machine's accessories include: Top Cover of the Outer Shell (1), the Bottom of the Outer Shell (2), Stainless Steel Slot (5), Basket for laying Vegetable and Fruit (14), Ultrasonic Implement (21), Ozone Generator (9), Reflux Controller (8), as well as High-low Water Level Sensors and related others. The design concept is that: there is a Basket (14) in the slot of the Top Cover (1) and Filtering Web (20) in the Stainless Slot (5). The Ultrasonic Implement (21) and Draining Wasted Water Aperture (23) are designed at the bottom. Reflux Entrance (6), Reflux Exit (7) and Overflowing Aperture (3) are design around the Draining Wasted Water Aperture (23). The Machine producing Bubbles (16) and Balances Localization Axis (15) are at the bottom of Stainless Steel Slot (5). Reflux Controller (8), Ozone Generator (9) and Draining Controller (24) are under the Slot (5). On the top edge and in the middle of Slot (5), there is High Water Lever Sensor (25) and Low Water Level Sensor (26) respectively. The Balance Localizations Revolving Axis (12) is in the middle of the Basket (14), which is also in the Slot (5) with a Basket Cover (29). The Below Balance localization Slot (27) is under the cone and the Top Balance localization Slot (28) as well as Switch Handle (11) are on the top. The Balances Circle is under the basket and the Outer of the Basket is designed the Revolving Blades (18). The Bottom of Outer Shell is design Draining Wasted Water Aperture (23). Open the Handle (10) and add water to the slot through Water-entering Aperture (4). If the water level is over high, water will overflow through the Overflowing Aperture (5). Then start the automatic Control Board (13) and Ultrasonic Implement (21) to make the clean water vibrating. Thus, the dirty and poison adhered to leaves are vibrated into water. At the same time, ozone, produced by Ozone Generator (9) will dissolve with the water through the entrance of Machine producing Bubbles (16) and resolve the poison. The bubbles can keep the vegetable and fruit fresh within the planned time of soakage. The current entering through the Reflux Entrance (6) is pressed by Reflux Controller (8) and then flow into the slot through the duct connected with Reflux Exit (7) to strike the Revolving Blades (18) and the basket. The revolving water will wash away the dirty and impurity on the surface of the vegetable and fruit. When the planned cleaning time is up, draining controller will discharge part of the wasted water firstly, and the remanent water will make the Reflux Controller (8) working continuously. So the Basket (14) will produce centrifugal power to achieve the purpose of desiccation. At the same time, the Basket Cover (29) can keep the flowing vegetable and fruit in water. When the planned desiccation time is up, the Draining Controller (24) will discharge all the wasted water in the slot automatically. In a word, this new machine is indeed practical and economic. It will bring about the innovation not only on the vegetable and fruit's cleaning, but also on the safety of people's diet.

What is claimed is:

1. A sterilization machine on vegetable and fruit includes a cleaning slot on the cover of the outer shell and a basket for laying vegetable and fruit with its characteristic of low friction balance equipment, made up of the basket's two hemispheres, the slot and the revolving blades under the basket.

2. According to claim 1, the machine's characteristic is that: starting the ozone generator, connected to the machine producing bubbles through duct, lots of bubbles are produced and dissolved with the water so as to clean, sterilize and keep fresh.

3. According to claim 1 therein the reflux equipment also can make the basket revolving to desiccate the vegetable and fruit with the centrifugal power.

4. According to claim 1, the machine's characteristic is the ultrasonic implement for further cleaning with high speed at the bottom of the cleaning slot.

5. According to claim 1, characteristic is the automatic draining controller on the edge and at the middle of the cleaning slot respectively. And at the bottom, under filtering web, there is a draining valve, controlling the wasted water draining.

6. According to claim 1 therein at the center of the basket, furthermore, there is a cone. When starting the reflux equipment, the vegetable and fruit will revolve along with the cone, which is easy for washing.

7. According to claim 1, characteristics are the special sterilization device and the combination of ozone generator machine producing bubbles and ultrasonic slot.

8. According to claim 1, characteristic is that the concave parenthetical design of the basket cover can keep the vegetable and fruit in water, without flowing out.

9. According to claim 2, the machine's characteristic is the ultrasonic implement for further cleaning with high speed at the bottom of the cleaning slot.

10. According to claim 2, characteristics are the special sterilization device and the combination of ozone generator machine producing bubbles and ultrasonic slot.

11. According to claim 4, characteristics are the special sterilization device and the combination of ozone generator machine producing bubbles and ultrasonic slot.

12. According to claim 9, characteristics are the special sterilization device and the combination of ozone generator machine producing bubbles and ultrasonic slot.
